(19) United States
(12) Patent Application Publication
(10) Pub. No.: US 2019/0118479 A1
(43) Pub. Date: Apr. 25, 2019

(54) MONITORING BUILD PLATFORM MOVEMENT FOR DRIVE CALIBRATION

(71) Applicant: HEWLETT-PACKARD DEVELOPMENT COMPANY, L.P., Houston, TX (US)

(72) Inventors: Francesc SALA ROURA, Sant Cugat del Valles (ES); Gonzalo GASTON LLADO, Sant Cugat del Valles (ES); Joan CAMPDERROS CANAS, Sant Cugat del Valles (ES); Pau SERRA BERGERON, Sant Cugat del Valles (ES)

(73) Assignee: HEWLETT-PACKARD DEVELOPMENT COMPANY, L.P., Houston, TX (US)

(21) Appl. No.: 16/088,611

(22) PCT Filed: Jan. 19, 2017
(86) PCT No.: PCT/US2017/014132

§ 371 Date: Sep. 26, 2018

(51) Int. Cl. B29C 64/393; B29C 64/241; B29C 64/245

(52) U.S. Cl. CPC B29C 64/393; B33Y 50/02; B29C 64/245; B29C 64/241

(57) ABSTRACT

In an example, a method includes controlling a drive mechanism (110) of an additive manufacturing apparatus (100) to move a build platform (104) of the apparatus relative a static member (102); monitoring the movement of the build platform (104) using an optical sensor (302) that senses relative displacement between the build platform (104) and the static member (102); and generating calibration data based on the movement of the build platform (104) for calibrating a drive controller (120) of the drive mechanism (110) to compensate for run-out effects in the movement of the build platform.

### BACKGROUND

Additive manufacturing systems that generate three-dimensional objects on a layer-by-layer basis have been proposed as a potentially convenient way to produce three-dimensional objects.

Additive manufacturing techniques may generate a three-dimensional object by the selective solidification of successive layers of a build material.

### BRIEF DESCRIPTION OF DRAWINGS

Non-limiting examples will now be described with reference to the accompanying drawings, in which:

FIG. 1 schematically shows an example additive manufacturing apparatus;

FIG. 2 schematically shows an example movement profile of a build platform of the additive manufacturing apparatus of FIG. 1;

FIG. 3 schematically shows an example kit for calibrating movement of the additive manufacturing apparatus;

FIG. 4 schematically shows a plan view of a kit for calibrating movement of the additive manufacturing apparatus as installed on the additive manufacturing apparatus of FIG. 1;

FIG. 5 schematically shows the kit of FIG. 4 in an engaged configuration;

FIG. 6 is a flowchart of an example method of calibrating an additive manufacturing apparatus;

FIG. 7 is a flowchart of a further example method of generating calibration data for calibrating an additive manufacturing apparatus; and

FIG. 8 schematically shows an example machine readable medium and processor.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example, on a build platform and processed layer by layer, for example within a fabrication chamber.

In some examples, selective solidification is achieved through directional application of energy, for example using a laser or electron beam which results in solidification of build material where the directional energy is applied. In other examples, at least one print agent may be selectively applied to the build material. For example, a coalescing agent (or ‘fusing agent’) may be selectively distributed onto portions of a layer of build material in a pattern derived from data representing a slice of a three-dimensional object to be generated. The coalescing agent may have a composition such that, when energy (for example, heat) is applied to the layer, the build material coalesces (fuses) and solidifies to form a slice of the three-dimensional object in accordance with the pattern. By selectively solidifying multiple layers of build material, a three-dimensional object can be generated.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

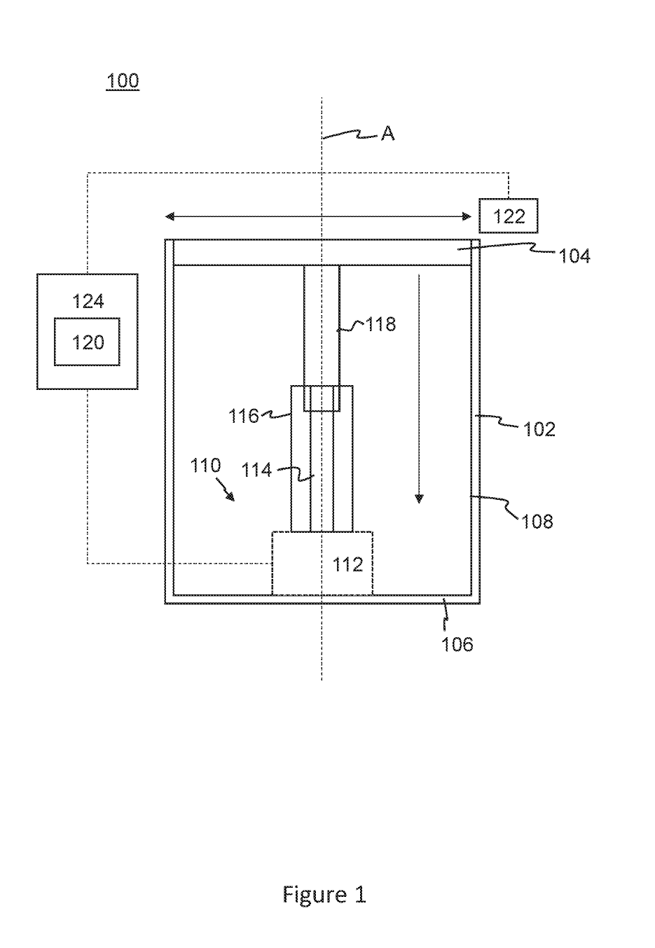

FIG. 1 shows a cross-sectional side view of an example additive manufacturing apparatus 100 comprising a chamber 102 and a build platform 104 moveable within the chamber 102 along a substantially vertical build axis A. In this example, the chamber 102 is a fabrication chamber into which the build platform 104 progressively descends as layer upon layer of build material is selectively fused on the build platform 104 in an additive manufacturing process to generate a three-dimensional object. In this particular example, the chamber 102 serves as a supply chamber to receive a build material for use in the additive manufacturing process. For example, the build material may be conveyed from within the chamber 102 and distributed on the build platform by distribution equipment (not shown).

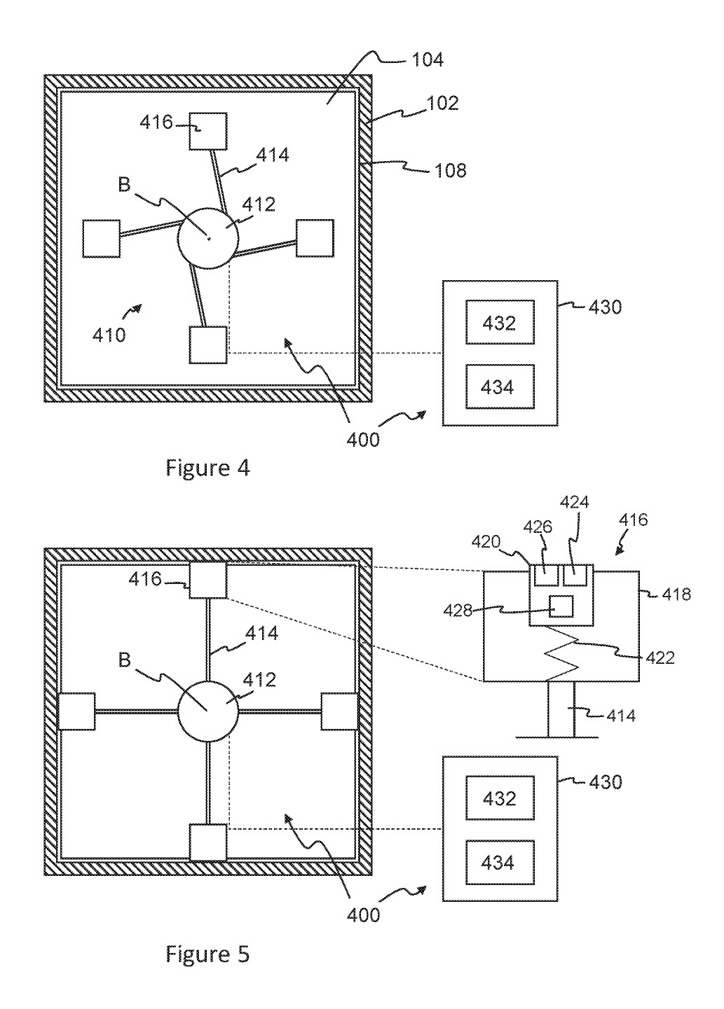

In this example, the build platform 104 has a substantially square upper surface (best shown in FIGS. 4 and 5) and the chamber 102 has an internal cross-section corresponding to the shape of the build platform 104, so that the build platform serves as a moveable upper enclosure for the chamber 102. In particular, the chamber 102 has a base 106 and four side walls 108 which correspond to four respective edges of the build platform 104.

The example additive manufacturing apparatus 100 comprises a drive mechanism 110 for moving the build platform 104 relative the chamber 102. In this example, the drive mechanism 110 comprises a motor 112 mounted on the base 106 of the chamber 102, a lead screw 114 rotationally coupled to the motor 112 and extending upward within the chamber in a lead screw housing 116, and a platform support 118 moveably mounted on the lead screw 114 and partially received within the lead screw housing 116. The platform support 118 supports the build platform so that in use, rotation of the motor 112 causes rotation of the lead screw 114 and vertical layer displacement of the platform support 118 and build platform 104.

The example apparatus 100 further comprises a drive controller 120 to control the drive mechanism to cause movement of the build platform 104 relative the chamber 102. For example, the drive controller may comprise a memory storing instructions to determine an amount of rotation of the motor to cause a specified displaement of the build platform based on evaluating a displacement function defined stored in the memory. The drive controller 120 may be to receive calibration data to calibrate the displacement function or define a calibrated displacement function, as will be described in detail below.

As shown in FIG. 1, in this example the apparatus 100 further comprises a carriage 122 to traverse over the build platform 104 to cause selective fusing of build material 104 received thereon. In this particular example, the carriage comprises a print agent applicator, such as a thermal or piezoelectric printhead to selectively eject a print agent onto the build material to control fusing of the build material. It will be appreciated that in other examples, the carriage 122 may comprise other components for controlling selective fusing of build material, and that two more more carriages may traverse the build platform 104 for different purposes during additive manufacture.

In this example, the carriage 122 is coupled to an additive manufacturing controller 124 for controlling an additive manufacturing process using the apparatus 100.

In this example, the additive manufacturing controller 124 comprises the drive controller 120 described above, however in other examples the drive controller 120 may be separate from the additive manufacturing controller. Further, in some examples the chamber 102, build platform 104, drive mechanism 110 and controller 120 may form a module for an additive manufacturing apparatus separate from components associated with causing selective fusing of build material (such as the carriage 122 and additive manufacturing controller 124). For example, the chamber 102, build platform 104, drive mechanism and controller 110, 120 may form a removable supply or fabrication chamber that can be installed in an additive manufacturing apparatus.

In an example additive manufacturing process, the additive manufacturing controller 124 controls distribution equipment (not shown) to cause a layer of build material to be applied onto the build platform 104. Subsequently, the controller 124 may control the carriage 122 to traverse the build platform 104 and cause selective fusing of the layer of build material. The controller 124 may further cause the drive mechanism 110 to move the build platform 104 downwardly into the chamber 102 in readiness for a subsequent layer of build material. Such movement of the build platform may be referred to herein as a layer displacement. Successive layers of build material may be applied and selectively fused, and the build platform 104 may be moved downwardly into the chamber 102 accordingly until the additive manufacturing process is completed. For example, the additive manufacturing controller 124 may specify that the build platform 104 is to move downwardly by 100 μm for each layer (i.e. a layer displacement of 100 μm), and the drive controller 120 may evaluate a displacement function stored in memory to determine how much to rotate the motor 112 to cause the specified layer displacement of 100 μm.

In order that an object generated by an additive manufacturing process as described above is accurately formed (i.e. accurately corresponds to a virtual component or instructions for the component), the manufacturing and operating tolerances for the drive mechanism for the build platform 104 may be minimised. For example, a component of the drive mechanism 110, such as the motor or lead screw may be provided with a high accuracy rotary encoder so that the rotation of the respective component can be accurately controlled to achieve a specified layer displacement of the build platform 104 (e.g. 100 μm). Further, the manufacturing tolerances on the lead screw and other rotational components may be minimised to minimise any run-out in the respective components which could lead to run-out effects in the movement of the build platform.

The term run-out refers to non-concentricity and/or alignment in rotational components. Run-out effects can be cyclical and/or cumulative. In the context of a drive mechanism for driving vertical movement of a build platform, cyclical run-out manifests as an oscillatory displacement error in the platform movement, whereas cumulative run-out manifests as a proportional error.

Cyclical run-out effects may result from radial-runout, which is caused by non-concentricity between the outer surfaces of a component (i.e. a drive thread on a lead screw) and the rotataional axis. In the example of a lead screw, radial run-out may be constant along the length of a lead screw. Cyclical run-out may also result from axial run-out, which is caused by angular mis-alignment between the tool and its axis of rotation. Axial run-out may cause one end of a component furthest from a supported base to rotate off-centre relative to the base. Accordingly, axial run-out may vary according to how far from the base it is measured, or which part of the component acts as a bearing surface for a mechanism (e.g. which part of the lead screw thread engages.

Cumulative run-out effects may result from diameter run-out, which is caused by variance in the diameter of a part relative its design value. In the context of rotational to linear translation, diameter run-out may cause the relationship between input rotation to output linear translation to be scaled by a consistent proportional factor.

Cumulative run-out may result from pitch run-out error in a threaded component such as a lead screw, thereby scaling the relationship between input rotation to output linear translation as described above. Cumulative run-out may further result from axial run-out, as described above.

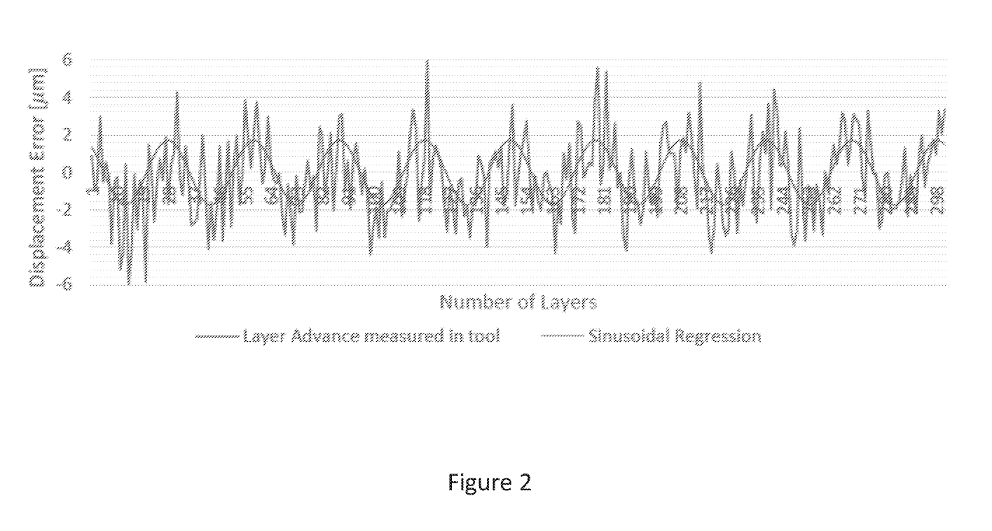

Nevertheless, run-out effects may persist in three-dimensional objects generated using an additive manufacturing apparatus 100 as described above. In particular, a run-out error in the lead screw 114 or other rotational component of the drive mechanism 110 may result in a cyclical run-out error or cumulative run-out error in the displacement of the platform. Accordingly, the actual vertical layer displacement of the platform between successive layers may be different to that specified or instructed by the drive controller 120. FIG. 2 shows an example profile of displacement error as determined by monitoring the movement of the build platform 104, as will be described in detail below. The displacement error is shown in units of μm (micrometers) and is obtained by substracting a specified movement profile (i.e. 100 μm per layer) from a monitored movement profile. The displacement error profile as shown in FIG. 2 relates to a cyclical run-out error associated with radial run-out, and is in the form of a noisy sinusoidal profile. The displacement error can be approximated by a sinuisoidal regression as overlaid on the displacement error profile.

Whilst the amplitude of the example displacement error profile is relatively small at approximately 2 μm, it may be discernible owing to its repeating nature, and therefore may affect the cosmetic appearance of a generated object.

An example kit and method for generating calibration data for calibrating a drive controller of an additive manufacturing apparatus will now be described.

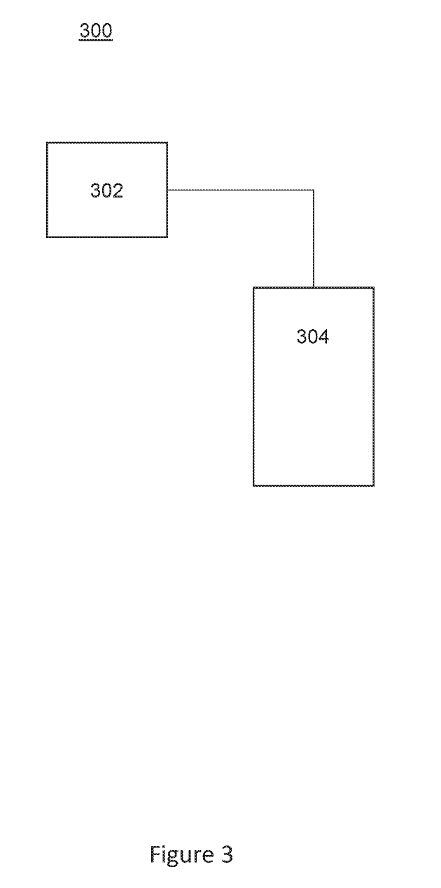

FIG. 3 schematically shows a calibration kit 300 comprising an optical sensor apparatus including an optical sensor 302 coupled to a calibration controller 304. The optical sensor 302 is to sense relative displacement between a build platform and a static member, for example a chamber wall such as a side walls 108 of the chamber 102 described above with respect to FIG. 1.

For example, the optical sensor 302 may comprises a light emitter such as an LED to illuminate a portion of a static member adjacent the sensor in use, such as a chamber wall (or side wall 108) of an additive manufacturing apparatus. The optical sensor 302 may further comprise an image sensor such as a CMOS image sensor to repeatedly image respective illuminated portions of the static member. The optical sensor 302 may be retrofitted to an additive manufacturing apparatus. For example, the optical sensor 302 may be disposed on or fixed to a build platform of an additive manufacturing apparatus. The optical sensor may be disposed on or fixed to a build platform in a location so that it opposes a static member such as a chamber wall of the additive manufacturing apparatus. The optical sensor 302 may comprise a mount for coupling to the build platform so that in use the optical sensor moves together with the build platform. The mount may comprise a base for the optical sensor, which may comprise a high-friction material such as rubber. The mount may comprise a fastener for coupling to the build platform, such as a suction cup, clip or mechanical fastener.

The calibration controller 304 or an integral signal processor of the optical sensor may determine the displacement of the optical sensor relative the static member, for example by comparing successive images of the static member. The light emitter may be to emit non-visible light, such as infrared.

The calibration controller 304 may comprise a processor and a memory storing instructions for monitoring movement of the build platform and generating calibration data, as will be described below. The calibration controller may be to receive a movement signal (an output signal) from the optical sensor 302 relating to the displacement of the respective optical sensor 302 and the respective static member. The calibration controller 304 may be to determine a movement profile over a succession of layers to determine a transient movement profile. The calibration controller 304 may be to determine run-out effects or errors in the transient movement profile, and may generate calibration data for calibrating the drive controller to compensate for such run-out effects, examples of which are provided in detail below.

FIGS. 4 and 5 schematically show, in plan view, an example optical sensor kit 400 as installed on an example build platform 104 of the apparatus 100 described above with respect to FIG. 1. The calibration kit 400 comprises an optical sensor apparatus 410 and a calibration controller 430.

In this example, the optical sensor apparatus 410 comprises a central mount 412 that is to be received on the upper surface of the build platform 104. The mount 412 has a base to be statically mounted on the upper surface of the build platform 104, and an upper body rotatably supported on the base about a central axis B which is substantially vertical when the mount 412 is located on the build platform 104. In this example, four arms 414 extend in a plane normal to the central axis B (i.e. in a plane parallel with the upper surface of the build platform 104) between the upper body of the mount 412 and respective sensor modules 416. The four arms 414 are distributed at equal angular intervals around the central axis B.

As shown in FIG. 4, the example optical sensor apparatus 410 is in a disengaged configuration in which each of the arms 414 are inclined relative a respective radial direction (i.e. a radial direction extending through the connection point between the arm 414 and the mount 412) so that the respective sensor module 416 is separated from the sidewall 108 of the chamber 102.

In this example, the optical sensor apparatus 410 is arranged on the build platform 104 so that rotation of the upper body of the mount relative the base (and thereby the build platform 104) causes each of the arms 414 to extend substantially radially so that the respective sensor modules 416 are extended radially to engage the side walls 108. The optical sensor apparatus 410 is shown in the engaged configuration in FIG. 5. It will be appreciated that the optical sensor apparatus 410 is but one example, and that in other examples an optical sensor apparatus may be provided to transition between disengaged and engaged configurations using other arrangements. In further examples, an optical sensor or sensor module (as described below) may be mounted or placed on the build platform to oppose the side wall or other static member, without selective actuation between engaged and disengaged configurations. There may be a plurality of such optical sensors or sensor modules.

As best shown in magnified view in FIG. 5, in this example each sensor module 416 comprises a housing 418 mounted on the distal end of a respective arm 414, an optical sensor 420 received within the housing, and a spring element 422 which acts between the proximal end of the housing 418 (i.e. the end closest the mount 412) and the optical sensor 420 to urge (or bias) the optical sensor 420 distally (i.e. away from the mount 412) against the side wall 108 of the chamber 102. By urging the optical sensor 420 against the side wall 108 (i.e. the static member relative to which the optical sensor 420 moves), the accuracy of the optical sensor may be optimised because the separation between the optical sensor 420 and the side wall 108 may be kept substantially constant. The example housing 418 has a distal opening and the optical sensor 420 is to partially project through the opening to engage the side wall 108 under the action of the spring element 422. Although in this example a sensor module 416 comprising a resilient member such as the spring element 422 is provided as part of the example four-arm optical sensor apparatus 410, in other examples a sensor module comprising an optical sensor and a resilient member may be provided independently, or may be coupled to a different arrangement of an optical sensor apparatus. For example, a sensor module comprising an optical sensor, a mount and a resilient member such as a spring element acting therebetween may be provided. The example sensor module may be placed or fixed on a build platform for sensing, such as in a location in which the optical sensor opposes a static member of an additive manufacturing apparatus such as a chamber wall (e.g. a side wall).

In this example, the optical sensor 420 comprises a light emitter 424 (in particular, an LED) to illuminate a portion of the side wall 108 adjacent the sensor 420; an image sensor 426 (such as a CMOS image sensor) to repeatedly image respective illuminated portions of the side wall 108 (e.g. by measuring light intensity falling on each of a plurality of pixel sensors of the CMOS image sensor), and an integral signal processor 428 to determine the displacement of the optical sensor 420 relative the side wall 108 by comparing successive images of the sidewall 108. The light emitter 424 may be to emit non-visible light, such as infrared. In other examples, signal processing to determine the displacement of the optical sensor 420 relative the side wall 108 may be done by the calibration controller 430, and there may be no integral signal processor in each of the optical sensors 420.

The example calibration controller 430 comprises a processor 432 and a memory 434 storing instructions for monitoring movement of the build platform and generating calibration data, as will be described below. The calibration controller 430 may be to receive a movement signal (an output signal) from each optical sensor 420 relating to the displacement of the respective optical sensor 420 and the respective side wall 108. The calibration sensor 430 may be to determine the movement (i.e. the layer displacement) of the build platform 104 relative the chamber 102 associated with each new layer based on each of the movement signals. In this particular example, there are four optical sensors 420 and the calibration sensor is to determine the movement of the build platform 104 based on averaging the displacements derived from the respective movement signals.

The calibration controller 430 may be to determine a movement profile over a succession of layers to determine a transient movement profile, and generate calibration data for calibrating the drive controller.

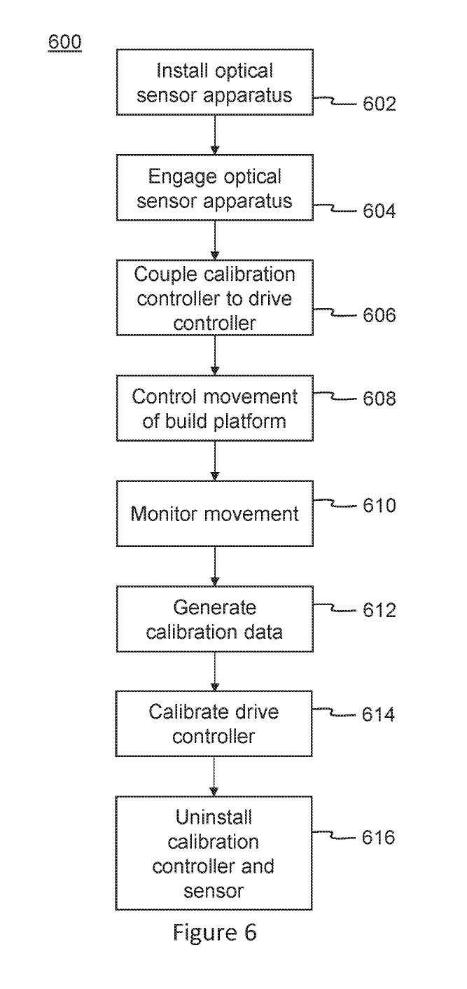

An example method of generating calibration data and calibrating a drive controller will now be described with respect to the example additive manufacturing apparatus 100 of FIG. 1 and the example calibration kit 400 of FIG. 4. FIG. 6 shows a flowchart for the example method 600. In this particular example, the calibration kit 400 is retrofitted to the additive manufacturing apparatus 100 (blocks 602-606), but in other examples components of the calibration kit may be integrally provided with the additive manufacturing apparatus 100.

In block 602, the optical sensor apparatus 410 is installed on the build platform 104 of the additive manufacturing apparatus 100. In this example, an optiThe optical sensor apparatus may be installed so that the or each optical sensor may move together with the build platform in use, and so that the or each optical sensor may oppose a chamber wall (e.g. a side wall 108) of the additive manufacturing apparatus 100. In this particular example, the optical sensor apparatus 410 may be installed by placing the mount 412 in a central location on the upper surface of the build platform.

The base of the mount 412 may be provided with a high friction material, such as rubber or an elastomer, to resist lateral movement on the build platform 104 during use. In other examples, the mount 412 or other portion of the optical sensor apparatus 410 may be secured to the build platform, for example by a clip, suction cup or mechanical fastener such as a bolt. The optical sensor apparatus 410 may be laid onto the build platform in the disengaged configuration in which the arms 414 are inclined relative a respective radial axis through the mount 412.

In this example, the optical sensor apparatus 410 may be installed in the disengaged configuration when the upper surface of the build platform 104 may be level or above the upper ends of the respective side walls 108. The build platform 104 may then be lowered down partially into the chamber 102 to a calibration start position in which the side walls 108 project above the upper surface of the build platform. In this particular example, the calibration controller 320 causes the build platform 104 to move to the calibration start position by sending an instruction to the drive controller 120, but in other examples the build platform 104 may be moved by manually instructing such movement via a controller of the additive manufacturing apparatus 100 (i.e. the additive manufacturing controller 124 or more particularly the drive controller 120). The controller of the additive manufacturing apparatus 100 may have a pre-set position associated with a calibration procedure.

In block 604, the upper body of the mount 412 may be rotated to place the optical sensor apparatus 410 in the engaged configuration in which the arms 414 extend radially and the sensor modules 416 provided on each arm are each disposed adjacent a respective side wall. In this configuration, the spring element 422 of each sensor module 416 biases the respective optical sensor 420 against the respective side wall 108 so that the light emitter 424 and the image sensor 426 are substantially fixed in their lateral separation from the side wall 108 as the build platform 104 and optical sensor apparatus 410 moves downwardly relative the side wall 108.

In block 606, the calibration controller 430 may be coupled to the optical sensor apparatus 410 to receive movement signals (output signals) from each of the optical sensors 420. The calibration controller 430 may be coupled to the drive controller 120 of the additive manufacturing apparatus 100 to communicate therewith. For example, it may be coupled by a USB, Bluetooth, Ethernet or wireless connection. In this particular example, calibration controller 430 is coupled to the drive controller 120 to receive a rotary encoder signal corresponding to the rotary or angular position of a component of the drive mechanism 110. For example, a rotary encoder may be provided on the lead screw 114 so that the rotary encoder signal directly corresponds to the rotary position of the lead screw 114. However, in other examples, a rotary encoder may be provided on another rotary component, such as the motor or an intermediate gear between the motor and lead screw 114 of the drive mechanism so that the rotary encoder signal indirectly corresponds to the rotary position of the lead screw. In further examples, there may be a sensor to determine when a revolution of the lead screw is completed, such as an optical sensor. Based on information from this sensor and a predetermined relationship between rotation of the motor and of the lead screw (i.e. a gear ratio), the calibration controller may determine the phase angle of the lead screw at any particular point of the operation of the drive mechanism. In such examples, there may be no rotary encoder.

In block 608, the drive mechanism 110 of the additive manufacturing apparatus is controlled to move the build platform 104 of the apparatus relative a static member. For example, the calibration controller 430 may send an instruction to the drive controller 120 to conduct a baseline movement of the build platform 104 relative a static chamber wall (e.g. a side wall 108) of the apparatus 100. In this example, the baseline movement is conducted using the same control procedures as are used to control movement of the build platform 104 during additive manufacture. For example, the drive controller 120 may evaluate a baseline displacement function to determine how much to rotate the motor 112 to cause a specified layer displacement of the build platform 104, which may be the same displacement function as is used in normal operation of the additive manufacturing apparatus. In this particular example, the baseline movement is instructed by the calibration controller 430 specifying a series of 100 μm downward movements (layer displacements) of the build platform 104 to the drive controller 130, thereby simulating instructions that may be received at the drive controller 120 during additive manufacture. In this particular example, the baseline movement comprises 300 consecutive layer displacements of 100 μm. For example, according to the baseline displacement function, a quarter turn of the motor may correspond to 100 μm layer displacement of the build platform. The drive controller 120 may monitor an output signal of the rotary encoder to determine when to stop rotating the motor.

In block 610, the movement of the build platform is monitored. The calibration controller 430 may receive movement signals from each of the optical sensors 420 for each layer displacement of the build platform and may determine the layer displacement of the build platform 104 accordingly. Each optical sensor may move together with the build platform, and may oppose the chamber wall. Movement of the build platform relative the chamber wall may therefore correspond to movement of the optical sensor relative the chamber wall it opposes so that the relative displacement of the build platform relative the chamber wall can be sensed by the optical sensor. Each optical sensor may be urged against a respective chamber wall. The calibration controller 430 may receive an output signal from the rotary encoder, which may be monitored by the calibration controller 430 and correlated with the respective movements of the build platform 104. An observed movement profile may be determined based on the succession of layer displacements that form the baseline movement of the build platform. In this particular example, the observed movement profile is the profile of displacement relative the calibration start position determined by the calibration kit 400 over the 300 layers of the baseline movement.

In block 612, calibration data is generated based on the movement of the build platform, for calibrating the drive controller 120 to compensate for run-out effects in the movement of the build platform. In this example, the calibration controller 430 generates the calibration data To generate the calibration data, the calibration controller 430 may subtract a specified movement profile for the baseline movement from the observed movement profile to isolate a displacement error profile (as shown in FIG. 2).

The calibration controller 430 may processes the displacement error profile to characterise the displacement error by trend analysis. In this example, the calibration controller 430 is to determine a cyclical run-out error and a cumulative run-out error, as described below.

As mentioned above, a cyclical run-out error may manifest as a substantially sinusoidal displacement error profile. There may be more than one mode of a cyclical run-out error. For example, two components in the drive mechanism 110 may be geared relative one another (i.e. there may be a gear ratio between them), such that respective run-out errors manifest with different amplitudes and frequencies. The calibration controller 430 may determine two or more individual run-out error modes, for example by conducting a Fourier transform of the displacement error profile and determining the properties of the respective frequencies components that generate the signal. In other examples, a sinusoidal profile may be determined using the least squares method (LSM).

For each cyclical run-out error, the calibration controller 430 may determine the amplitude of the error. The calibration controller 430 may correlate the output signal of the encoder with the displacement error profile in order to match the phase of the drive mechanism with the phase of the cyclical run-out error. The phase angle of the cyclical run-out error may be determined relative an initial angle corresponding to a displacement error of sin(0) (i.e. an initial angle of 0°). The phase angle of the drive mechanism may be determined relative an initial angle for the lead screw, the motor, or whichever component is directly coupled to the rotary encoder. For example, the output signal of the rotary encoder may indicate the phase angle of the lead screw in a range of 0° to 360° relative an initial orientation of the lead screw. By correlating the output signal of the encoder with the displacement error profile, the calibration controller 430 may determine the phase angle of the lead screw relative its initial orientation which corresponds to the initial angle of the cyclical run-out error.

For example, the calibration controller may determine that the cyclical run-out error has an amplitude of 2 μm, a frequency corresponding to the frequency of rotation of the lead screw, and an initial angle (at which the displacement error is zero) corresponding to a phase angle of the lead screw of 45° relative the initial orientation of the lead screw. Accordingly, in this particular example it can be predicted that the positive and negative peaks of the cyclical run-out error will occur when the phase angle of the lead screw is at 135° and 315° respectively, with zero run-out error when the phase angle of the lead screw is at 45° and 225°.

In other examples, a rotary encoder may be coupled to a different component of the drive mechanism to that which is the cause of the cyclical run-out error. For example, the rotary encoder may be coupled to the motor, and the lead screw may be the cause of a cyclical run-out error. There may be a gear ratio between the two, such that the frequency of the cyclical run-out error is different from the frequency of rotation of the motor as monitored by the rotary encoder. For example, the calibration controller may determine that a cyclical run-out error associated with the lead screw has a frequency which is half that of the frequency of rotation of the motor. In yet further examples, there may be no rotary encoder, and the phase angle of the lead screw may be determined using a sensor that determines each complete revolution of the lead screw, as mentioned above.

Further, the calibration controller may determine two or more superimposed cyclical run-out errors in the displacement error signal, each associated with a different rotary component of the drive mechanism 110 or run-out mode (e.g. radial run-out and axial run-out).

The calibration controller may determine a cumulative run-out error in the baseline movement of the build platform. For example, a cumulative run-out error may be determined as a non-cyclical component of the displacement error profile. The cumulative run-out error may be relatively small in each layer, as compared with the amplitude of a cyclical run-out error, but may build over a succession of layers to have an appreciable effect on the geometry of an object generated by additive manufacture.

The calibration controller 430 may determine the cumulative run-out error by analysing a cumulative discrepancy between the specified and observed movement profiles over the baseline movement. For example, a layer displacement of the build platform of 100 μm may be specified for each layer, and the calibration controller may determine that the average (observed) layer displacement over 300 layers is 99.5 μm per layer. By determining the cumulative run-out error over a baseline movement corresponding to a plurality of individual layer displacements, the cumulative run-out error may be more accurately resolved. The cumulative run-out error may correspond to axial misalignment of the leadscrew (axial run-out), diameter run-out, or a pitch error in the lead screw or other threaded component in the drive mechanism.

Generating the calibration data may comprise determining the frequency, amplitude and phase offset (i.e. the offset between the initial angle of the cyclical run-out error and the initial orientation of the lead screw) for each cyclical run-out error; and determining a scale factor or percentage cumulative run-out error. The amplitude for a cyclical run-out error and the scale factor for a cumulative run-out error may be non-linear. For example, when run-out error relates to axial run-out, the amplitude (cyclical) or scale factor (cumulative) may be a function of the position of the build platform in the chamber, which corresponds to position along the lead screw which engages the platform support. Accordingly, the calibration data may be a function of position of the build platform in the chamber or a related parameter (such as the position of the platform support on the lead screw).

In block 614, the drive controller 120 is calibrated based on the calibration data. The drive controller 120 may be to receive inputs for adjusting the relationship (i.e. a displacement function) between a specified displacement and rotation of the motor to compensate for run-out errors. For example, the drive controller 120 may have a predetermined baseline displacement function for determining the amount of rotation of the motor to achieve a specified displacement of the build platform, as described above. The baseline displacement function may assume a linear relationship between the amount of rotation of the motor and the displacement of the build platform, independently of the phase of the motor or lead screw.

The drive controller 120 may be to receive inputs for defining a calibrated displacement function for determining the amount of rotation which compensates for the or each run-out error determined in block 612. The calibrated displacement function may include a cumulative parameter for linearly adjusting a specified displacement to compensate for the cumulative run-out error. For example, the cumulative parameter may be a scalar factor for calibrating the amount of rotation. Further, the calibrated displacement function may include cyclical parameters for compensating for the or each cyclical run-out error based on the amplitude, frequency, and phase offset of the or each cyclical run-out error.

In an example described above, an example cyclical run-out error has an amplitude of 2 μm, a frequency corresponding to the frequency of rotation of the lead screw (i.e. the same frequency), and an initial angle (at which the displacement error is zero) corresponding to a phase angle of the lead screw of 45° relative the initial orientation of the lead screw. Accordingly, the cyclical parameters of the calibrated displacement function may be defined to apply an out-of-phase cyclical correction having an amplitude of 2 μm, a frequency corresponding to the frequency of rotation of the lead screw, and an initial angle corresponding to a phase angle of the lead screw at 225°.

The calibration controller 430 may interface with the drive controller 120 to directly specify the cumulative and cyclical parameters in the drive controller 120, for example, by transmitting the parameters by a data connection such as a USB, Ethernet or a wireless connection, for storage in a memory of the drive controller 120. In other examples, the cumulative and cyclical parameters may be input or adjusted in the drive controller 120 in other ways. For example, a user may manually input the parameters based on an output from the calibration controller (for example, an output via a display, print-out, or electronic message sent from the calibration controller 430). In a further example, the parameters may be uploaded from the calibration controller 430 to a cloud service, and subsequently downloaded to the drive controller 120 via an update to the additive manufacturing apparatus.

In block 616, the calibration kit 400 is removed from the additive manufacturing apparatus 100 by disconnecting the calibration controller 430 from the drive controller 120, and removing the optical sensor apparatus 410 from the build platform 104.

Where a drive controller 120 includes a baseline displacement function and a calibrated displacement function associated with a previous calibration, the baseline movement in block 608 may be conducted based on the baseline displacement function.

After the calibration method 600, further operation of the additive manufacturing apparatus 100 may be based on the calibrated displacement function, such that run-out effects that would be present in un-calibrated movement of the build platform are compensated for and avoided or mitigated in an additive manufacturing process.

By calibrating the drive controller as described above, run-out errors inherent in the drive mechanism can be compensated for. Accordingly, stringent tolerances for components in the drive mechanism may be relaxed, which may enable such components to be sourced and manufactured more efficiently and at lower cost, with lower part rejection due to tolerance issues.

A further example method of generating calibration data will now be described with respect to the example additive manufacturing apparatus 100 of FIG. 1 and the example calibration kit 300 of FIG. 3.

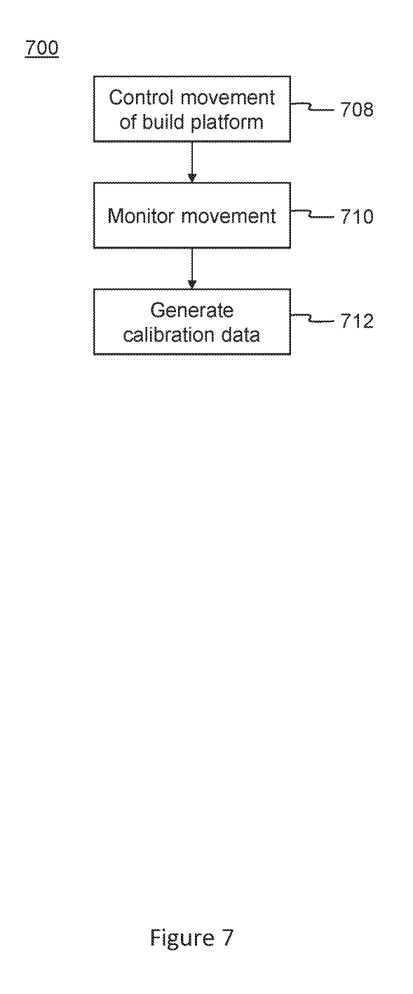

FIG. 7 is a flowchart of a method 700 of generating calibration data. In block 708, the build platform 104 is caused to move relative chamber 102, which is static. For example, the build platform 104 may be caused to move by instructing movement of the build platform using the additive manufacturing controller 124 of the apparatus 100, without instruction from the calibration controller 302. For example, the additive manufacturing controller 124 may comprise pre-stored instructions for controlling a baseline movement of the build platform for the purposes of calibration, or may be to receive inputs for manual control of the drive mechanism and build platform. In other examples, the calibration controller 302 may communicate with the additive manufacturing controller 124 to initiate such movement.

In block 710, the optical sensor 302 of the calibration kit 300 senses relative displacement between the build platform and the chamber 102. The movement of the build platform may be monitored using the optical sensor 302. For example, the calibration controller 304 may monitor the movement of the build platform based on an output of the optical sensor 302 corresponding to the relative displacement between the build platform 104 and the chamber 102. For example, monitoring movement of the build platform may comprise determining a cyclical run-out error in the movement of the build platform 104. The optical sensor 302 may be pre-installed on the build platform, and in some examples may be integral to the build platform.

In block 712, calibration data is generated based on the movement of the build platform, for example by the calibration controller 304. The calibration data can be used to calibrate the drive controller 120 of the drive mechanism 110 to compensate for run-out effects in the movement of the build platform. For example, the calibration data may define a sinusoidal correction that can be applied in the drive controller to compensate for a radial run-out error inherently present in the drive mechanism 110.

By generating the calibration data as described above, a drive controller of a drive mechanism may subsequently be calibrated to compensate for run-out effects in the movement of the build platform. Such calibration may be done separately to the generation of the calibration data.

In the examples described above, the calibration kit may be separate from an additive manufacturing apparatus and can be coupled thereto to perform a one-time or periodic calibration, for example as described with above with respect to blocks 602 to 606 of FIG. 6. For example, the calibration kit may be used be service personnel to periodically service any number of additive manufacturing apparatus.

In other examples, components of the calibration kit as described above may be integral with an additive manufacturing apparatus. For example, an optical sensor may be installed together with a build platform, for example in an edge of the build platform or below the build platform and within a corresponding chamber. A calibration controller may be provided in the additive manufacturing apparatus, for example as a module within the additive manufacturing controller.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

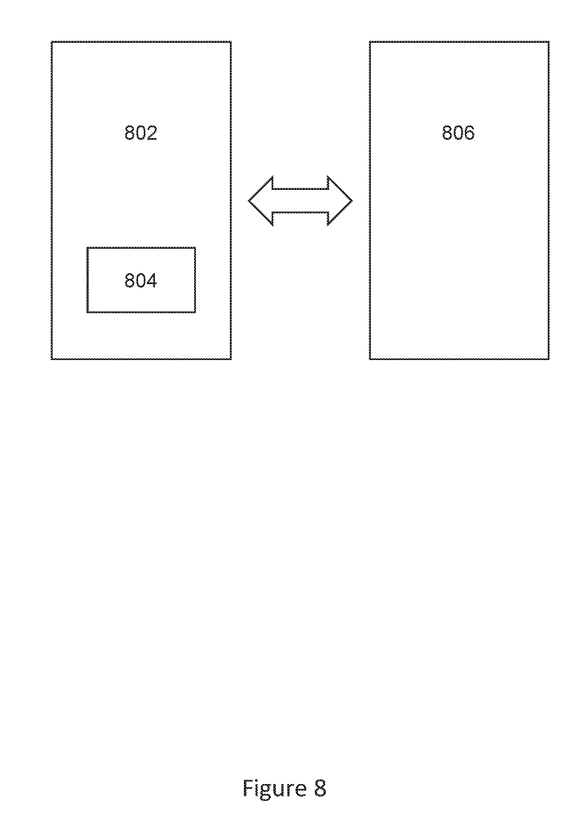

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions. FIG. 8 shows a machine readable medium 802 comprising instructions 804 for carrying out a method of calibrating a drive controller (as described with respect to FIG. 6) or a method of generating calibration data for calibrating a drive controller (as described with respect to FIG. 7), when executed by a processor 806.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors. For example, the machine readable instructions may be stored in the memory 434 of the calibration controller 430 described above with respect to FIGS. 4 and 5, and may be executed by the processor 432 of the calibration controller 430 as described above.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
controlling a drive mechanism of an additive manufacturing apparatus to move a build platform of the apparatus relative a static member;
monitoring the movement of the build platform using an optical sensor that senses relative displacement between the build platform and the static member;
generating calibration data based on the movement of the build platform for calibrating a drive controller of the drive mechanism to compensate for run-out effects in the movement of the build platform.

2. A method according to claim 1, wherein the static member is a chamber wall of a chamber surrounding the build platform, and wherein the optical sensor moves together with the build platform, and wherein the optical sensor opposes the chamber wall as the build platform moves within the chamber.

3. A method according to claim 2, wherein the optical sensor is urged against the chamber wall during monitoring of the movement of the build platform.

4. A method according to claim 1, further comprising retrofitting the optical sensor to the build platform of the additive manufacturing apparatus.

5. A method according to claim 1, further comprising determining a run-out error in the movement of the build platform; and wherein the calibration data is generated based on the run-out error to adjust a parameter of the drive controller to compensate for the run-out error.

6. A method according to claim 1, further comprising calibrating the drive controller of the drive mechanism based on the calibration data to compensate for run-out effects in the movement of the build platform.

7. A method according to claim 6, further comprising coupling a calibration controller for generating the calibration data to the drive controller of the apparatus; wherein the calibration controller causes the drive controller to move the build platform and calibrates the drive controller based on the calibration data.

8. A machine readable medium comprising instructions which, when executed by a processor, cause the processor to:
receive a movement signal from an optical sensor to sense relative displacement between a build platform of an additive manufacturing apparatus and a static member;
determine a movement profile of the build platform based on the movement signal; and
generate calibration data based on the movement profile for calibrating a drive controller of a drive mechanism for the build platform to compensate for run-out effects in the movement profile of the build platform.

9. A machine readable medium according to claim 8, wherein the instructions, when executed, cause the processor to determine a run-out error in the movement profile of the build platform and generate the calibration data based on the run-out error to adjust a parameter of the drive controller to compensate for the run-out error.

10. A machine readable medium according to claim 8, wherein the instructions, when executed, cause the processor to calibrate the drive controller of the drive mechanism based on the calibration data to compensate for run-out effects in the movement profile of the build platform.

11. A kit comprising:
an optical sensor apparatus comprising an optical sensor for sensing relative displacement between a build platform of an additive manufacturing apparatus and a static member; and
a calibration controller to monitor movement of the build platform based on a movement signal from the optical sensor; and to generate calibration data based on the movement of the build platform for calibrating a drive controller of a drive mechanism for the build platform to compensate for run-out effects in the movement of the build platform.

12. A kit according to claim 11, wherein the optical sensor apparatus comprises a mount for coupling to the build platform so that in use the optical sensor moves together with the build platform and relative to the static member.

13. A kit according to claim 12, wherein the optical sensor apparatus comprises a resilient member acting between the mount and the or each optical sensor to urge the respective optical sensor against the static member.

14. A kit according to claim 11, wherein the calibration controller is to communicate with the drive controller; and is to calibrate the drive controller based on the calibration data to compensate for run-out effects in the monitored movement of the build platform.

15. A kit according to claim 11, wherein the optical sensor apparatus comprises a plurality of optical sensors, wherein each sensor is to sense relative displacement between the build platform and a respective static member.
